(19) United States
(12) Patent Application Publication
(10) Pub. No.: US 2026/0052284 A1
(43) Pub. Date: Feb. 19, 2026

(54) Personalized Playback Experiences via Recipe Resolution

(71) Applicants: Disney Enterprises, Inc., Burbank, CA (US); HULU, LLC, Santa Monica, CA (US); Beijing YoJaJa Software Technology Development Co., Ltd., Beijing (CN)

(72) Inventors: Zachary McKeel Cava, Seattle, CA (US); Jeffrey Border, Encino, CA (US); Charles Rumley, Berrien Springs, MI (US); Kyle Glossy, Denver, CO (US); James Trollo, Chatham, NJ (US); Taylor Deehan, Southport, CT (US); Alfonso Sosa, Marina del Rey, CA (US); Akinwale Olugbile, San Diego, CA (US); Mo Cheng, Beijing (CN); Kevin Fuhrman, Campbell Hall, NY (US); Stephen Bly, New York, NY (US)

(73) Assignees: Disney Enterprises, Inc., Burbank, CA (US); HULU, LLC, Santa Monica, CA (US); Beijing YoJaJa Software Technology Development Co., Ltd., Beijing (CN)

(21) Appl. No.: 18/803,471

(22) Filed: Aug. 13, 2024

(51) Int. Cl. H04N 21/234; H04N 21/24; H04N 21/262; H04N 21/81; H04N 21/845

(52) U.S. Cl. CPC H04N 21/23424; H04N 21/2407; H04N 21/26208; H04N 21/812; H04N 21/8455

(57) ABSTRACT

In some embodiments, a method receives a request for playback of primary content. The request is associated with a distribution context. Decorations are determined for a set of insertion points. The method selects inclusion rules for the distribution context. The inclusion rules include a template describing references for supplemental content or default supplemental content for types in the set of types. Types are evaluated for the set of insertion points using the template to determine an experience timeline in which insertion points are associated with references for supplemental content or default supplemental content for types. The method determines playback materials for the set of insertion points in the primary content based on the references for supplemental content or default supplemental content for types in the set of types for the experience timeline. A set of instances of supplemental content is inserted in the insertion points.

### BACKGROUND

There may be multiple video delivery applications that provide content delivery services. Each service may individually provide different experiences while delivering content. For example, even if the same piece of content is delivered by the different services, the experience that is offered during the delivery of content may be different, such as different permutations of supplemental content may be inserted in the breaks of the content. Each application may create fixed permutations for insertion. The independent applications may use a large amount of resources of storage and computing processing by individually programming each respective permutation for the experiences.

### BRIEF DESCRIPTION OF THE DRAWINGS

The included drawings are for illustrative purposes and serve only to provide examples of possible structures and operations for the disclosed inventive systems, apparatus, methods and computer program products. These drawings in no way limit any changes in form and detail that may be made by one skilled in the art without departing from the spirit and scope of the disclosed implementations.

FIG. 1 depicts a system for a using recipes to insert content according to one embodiment.

FIG. 2 depicts different distribution contexts according to some embodiments.

FIG. 3 depicts an example of creating an experience timeline according to some embodiments.

FIG. 4 depicts an example of an experience timeline using dirty copies of assets according to some embodiments.

FIG. 5 depicts an example of a base presentation timeline with a set of insertion points for an experience timeline according to some embodiments.

FIG. 6 depicts an example of the experience timeline according to some embodiments.

FIG. 7 depicts examples of resolvers according to some embodiments.

FIG. 8 depicts a more detailed example of a recipe manager according to some embodiments.

FIG. 9 depicts an example of a recipe according to some embodiments.

FIG. 10 depicts a simplified flowchart for processing playback of primary content according to some embodiments.

FIG. 11 depicts an experience timeline that is resolved from the media presentation timeline according to some embodiments.

FIG. 12 depicts an example of the selected inclusion rules according to some embodiments.

FIG. 13 depicts an example of an experience timeline after evaluation of the inclusion rules according to some embodiments.

FIG. 14 depicts an example of playback materials for server guided ad insertion (SGAI) of the bumper types according to some embodiments.

FIG. 15 depicts an example of playback materials for SGAI of the advertisement types according to some embodiments.

FIG. 16 depicts an example of playback materials for server side ad insertion (SSAI) of the bumpers according to some embodiments.

FIG. 17 depicts an example of playback materials for SSAI of the advertisement references according to some embodiments.

FIG. 18 depicts a first example of inclusion rules for a first distribution context and a second example of inclusion rules for a second distribution context according to some embodiments.

FIG. 19 depicts a third example inclusion rules for a third distribution context according to some embodiments.

FIG. 20 illustrates one example of a computing device according to some embodiments.

### DETAILED DESCRIPTION

Described herein are techniques for a content delivery system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system may use componentized content to provide unique playback experiences across supported distribution contexts. A set of recipes are defined that allow the creation of experiences across the different distribution contexts. The distribution context may be based on different applications that offer distinct content delivery services. There may be content sources, which may be entities (e.g., brands) that have content rights. Content sources may be content source #1, #2, #3, #4, #5, etc. The distribution contexts may be the applications of consumption, such as application #1, application #2, application #3, etc. Application #1 may consume content source #1 and content source #2. Application #2 may consume content source #3, and application #3 may consume content source #2, content source #3, content source #4, and content source #5.

The system may use content timelines that can be combined to create unique experiences dynamically for the delivery of content instead of using the fixed creation of playback permutations for each distribution context. The experiences may be playback sequences that may include the primary content interleaved with supplemental content, which may be global supplemental content or context specific supplemental content, to produce a playback session. The global supplemental content may be content that is played across different distribution contexts. The context specific supplemental content may be content that is selected for a specific distribution context. Different context specific supplemental content may be selected for another distribution context (or context specific supplemental content does not exist for the other delivery context). The playback session may be tailored to multiple attributes, such as distribution context, user preference, content rights, application requirements, advertising opportunities, device restrictions, and local restrictions. Some or all of the attributes may be used by the system to determine a recipe that can be applied to the playback experience.

Recipes may include base media timeline decorations and inclusion rules. The base media timeline decorations may specify different types of supplemental content to include during insertion points of primary content. The types may be different categories of supplemental content, such as bumpers, advertisements, in-stream promos, etc. The bumpers may be content or product-specific assets to provide attribution and awareness information about the primary content to the user. Advertisements may be user targeted-advertisements or other types of ads. In-stream promos may be content campaigns for awareness of the brand offerings.

The types may be further resolved based on inclusion rules. The inclusion rules may resolve the types based on an insertion template. The insertion template describes the content references to include in a manifest and how to treat default content. In some examples, first inclusion rules may be used for a first distribution context. However, a second distribution context may use second inclusion rules. The first inclusion rules may include the types of bumpers, advertisements, post content and the second inclusion rules may include the types of advertisements and in-stream promos.

Playback orchestration systems may evaluate the inclusion rules to generate an experience timeline for instances of supplemental content. The experience timeline may include specific instances of supplemental content or references to types of supplemental content that can later be resolved during playback. It is noted that the instances of supplemental content may be different for the same types between the different distribution contexts depending on the attributes of the playback session. However, the insertion points using the same recipe may include the same types.

The use of the recipes may improve the delivery process. For example, when primary content is being played back, recipes may be used to dynamically determine different experiences may be provided for different distribution contexts. This may allow the reuse of the content components that are being provided during the experiences. This improves the storage usage and delivery efficiency because applications may share access to the same piece of content on a content delivery network. Also, the use of recipes may allow the dynamic insertion of different types of supplemental content for different experiences. This may allow for different experiences to be added at scale by adding new recipes. The use of types and inclusion rules provide flexibility for playback systems of different distribution contexts to provide different timeline experiences. For example, different types may be resolved to different experiences using different inclusion rules. Previously, the pieces of content would be duplicated per distribution context to tailor them for that context and/or a system was only for a single distribution context and hardcoded the insertion of supplemental content. The recipes enable both the vector of improved storage and delivery efficiency, but also multi-distribution context management from a central authority system.

### System

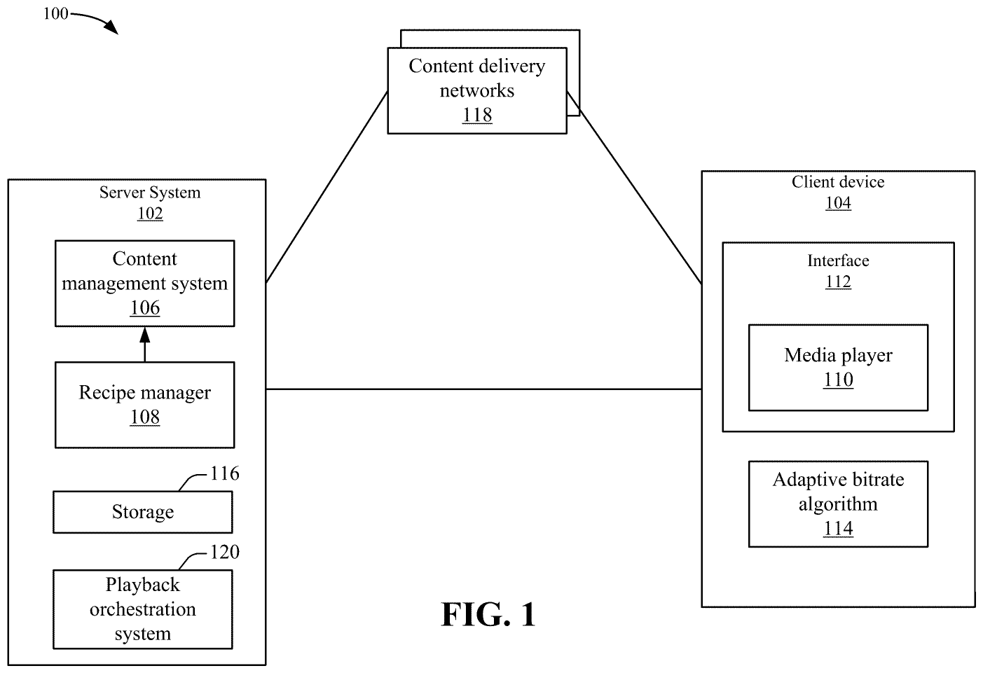

FIG. 1 depicts a system 100 for a using recipes to insert content according to one embodiment. System 100 includes a server system 102, content delivery networks 118, and a client device 104. Although one instance of server system 102 and client device 104 are shown, multiple instances of server system 102 and client device 104 may be used. Functions described may also be distributed among entities.

Server system 102 includes a content management system 106 that may facilitate the delivery of content to client device 104. For example, content management system 106 may communicate with multiple content delivery networks 118 (also referred to as a content delivery network 118) to have content delivered to multiple client devices (not shown). A content delivery network 118 includes servers that can deliver content to client device 104. The content may be video, audio, images, text, or other types of content. Video may be used for discussion purposes, but other types of content may be used in place of video. In some embodiments, content delivery network 118 delivers segments of video to client device 104. The segments may be a portion of the video, such as six seconds of the video. A video may be encoded in multiple profile levels that correspond to different levels, which may be different levels of bitrates or quality (e.g., resolution). Client device 104 may request a segment of video from one of the profile levels based on current network conditions. For example, client device 104 may use an adaptive bitrate algorithm 114 to select the profile level for the video based on the estimated current available bandwidth and other network conditions.

Client device 104 may include a mobile phone, smartphone, set top box, television, living room device, tablet device, gaming consoles, or other computing device. Client device 104 may include a media player 110 that is displayed on an interface 112 and can play the content. Media player 110 or client device 104 may coordinate playback of the content via content management system 106 and content delivery network 118 during a playback session for the content.

Client device 104 sends a request for primary content to content management system 106. Then, client device 104 may receive information to select a content delivery network 118. Content delivery network 118 may send a manifest (also referred to as a playlist) that lists segments for the primary content (and available bitrates). Then, client device 104 (e.g., media player 110) may request segments of the primary content from content delivery network 118. While receiving the segments of the primary content, client device 104 can evaluate the bandwidth in which client device 104 receives the segments and select different segments of different bitrates.

A transport mechanism, such as a protocol specification including Dynamic Adaptive Streaming over HTTP (DASH), also known as MPEG-DASH, may be used to transport segments of the content to client device 104. However, HTTP Live Streaming (HLS) or other protocols may also be used. Adaptive bitrate algorithm 114 may determine when to switch to a different bitrate version of the content. The adaptive bitrate algorithm analyzes the available bandwidth and possibly other factors (e.g., computer processing unit load) to determine when to switch to a different bitrate. For example, if the adaptive bitrate algorithm determines that the available bitrate is 2 Mbps and client device 104 is requesting segments of the content at a bitrate of 1 Mbps, the adaptive bitrate algorithm may determine that client device 104 should request segments of the content encoded at 2 Mbps.

A recipe manager 108 manages recipes that are stored in storage 116 and used in the content delivery process. A recipe provides a template for how independent content assets should be interleaved together in a playback session. When a request for primary content occurs, recipe manager 108 may select a recipe based on a context of the playback session. For example, a distribution context is used to select the recipe. A selected recipe may include a decorated base media timeline and content inclusion rules for insertion points.

A decorated base media timeline is generated and stored with other media metadata. The timeline decoration specifies content insertion points for insertion of supplemental content. For the insertion points, replacement operations can be established using different types of supplemental content to insert. Each insertion point may be associated with a media timeline unique identifier. Inclusion rules can be defined for the insertion points. The rules may provide criteria to select inclusion rules for an insertion point. The inclusion rules include an insertion template that describes the usage of content that may be inserted at the insertion point.

The inclusion rules detail how the insertion points should be handled for a given combination of a type and other attributes, such as from the playback session. Each type may have a set of default behavior defined, but additional specificity and behavior can be defined by variants that are targeted to specific playback attributes using inclusion rules. When an experience is created for a playback session, a type definition may be selected, and then inclusion rules with the largest set of matching criteria to the playback session are selected to further resolve the types based on a distribution context.

A playback orchestration system 120 orchestrates the playback of experience timeline based on the recipe. As will be discussed below, playback orchestration system 120 may generate a manifest. Also, playback orchestration system 120 may resolve references for content, if needed. Although playback orchestration system 120 is described as being in server system 102, playback orchestration system 120 may be found in other entities, such as content delivery networks 118. Also, each distribution context may have a specific playback orchestration system 120 that resolves recipes for playback.

The following will now describe concepts for using recipes in more detail.

### Distribution Contexts

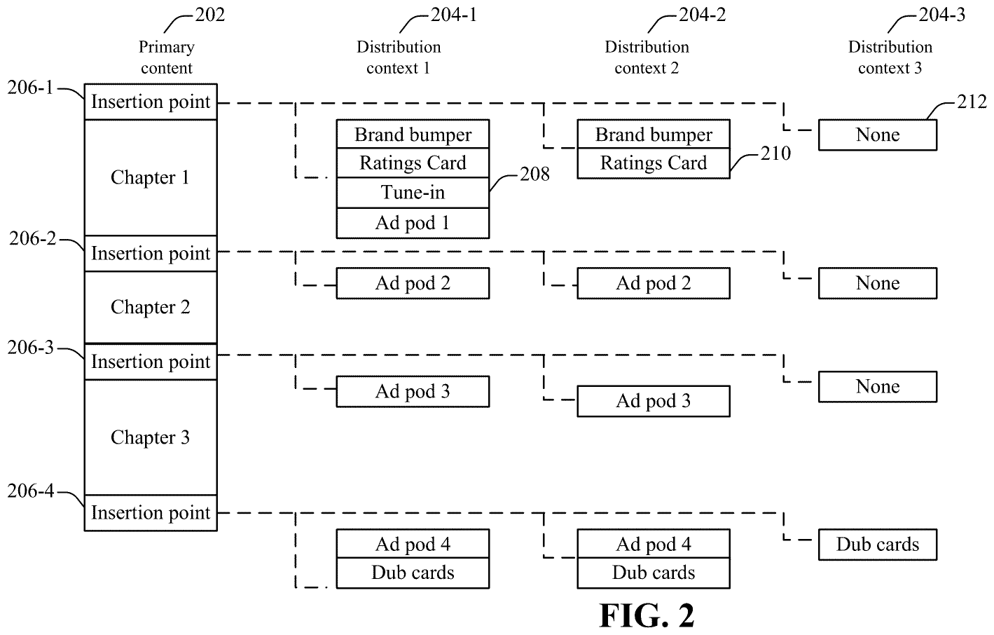

FIG. 2 depicts different distribution contexts according to some embodiments. At 202, primary content may be content that was selected for playback in the playback session. For example, primary content may be a movie, show, etc. Different distribution contexts are shown at 204-1, 204-2, 204-3. The distribution context may be associated with different applications that provide different services. The different distribution contexts may result in different experiences. For example, a first application may provide a first experience, a second application may provide a second experience, and a third application may provide a third experience. However, multiple distribution contexts may provide the same experience if the same recipe is used. Also, the experience may be the same for multiple users of the service in that the same types of supplemental content are used although the specific instances of supplemental content may be different for different playback sessions that use the same recipe.

Primary content 202 includes multiple insertion points, 206-1, 206-2, 206-3, and 206-4. The insertion points may be interspersed in the playback of primary content, which may be portions of primary content that are labeled chapter 1, chapter 2, and chapter 3. The insertion points may be at the beginning of playback (before playback of the primary content starts), in the middle of playback, or at the end of playback. At each insertion point, supplemental content may be inserted in the playback session (or no supplemental content is inserted if not available).

The experiences that occur in the playback session may be different for different distribution contexts. The following supplemental content may be inserted for different experiences for insertion point 206-1. For example, at 208, for the distribution context at 204-1, the supplemental content that are inserted may include a brand specific bumper, a ratings card, a tune-in, and an ad pod 1. The ratings card may describe the rating of the primary content. The ad pod may be a slot for inserting advertisements. At 210, for the distribution context at 204-2, the experience may include a brand bumper and the ratings card. Then, at 212, for the distribution context at 204-3, no supplemental content may be inserted.

For insertion points 206-2, 206-3, 206-4, different experiences may also be provided as shown. For example, for insertion point 206-2, an ad pod 2 is shown for the distribution contexts at 204-1 and 204-2 and no supplemental content is inserted for the distribution context at 204-3. It is noted that these experiences are shown as examples, and different variations may result based on different recipes that are associated with the different experiences. Conventionally, each permutation for the experiences may have been individually created for each respective distribution context. However, using recipes, the different experiences may be provided using types that resolve to different content components. The following will describe different aspects of the reuse.

### Timelines

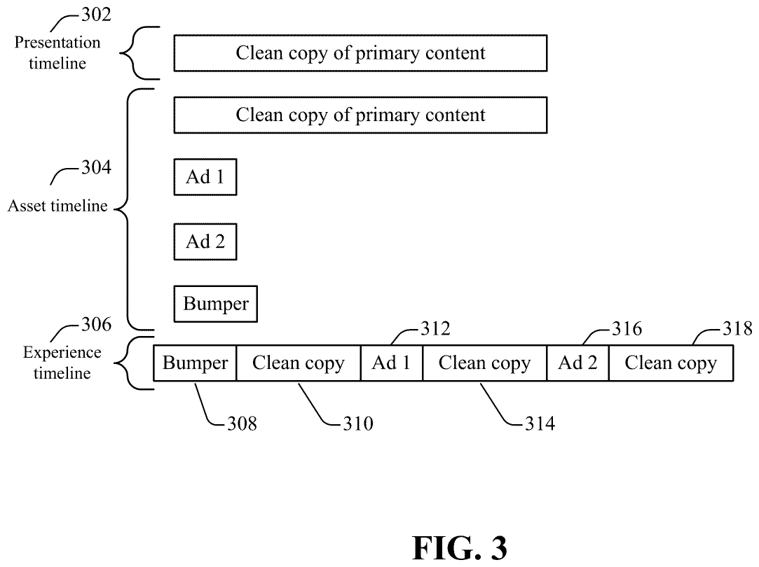

Recipes operate to create an experience timeline that is experienced in a playback session. There is a presentation timeline of primary content and asset timelines for content. The following describes the timelines. FIG. 3 depicts an example of creating an experience timeline according to some embodiments. At 302, a presentation timeline is shown, at 304, asset timelines are shown, and at 306, an experience timeline is shown. The experience timeline may be used to describe the playback experience. When starting a playback session based on a request from client device 104, client device 104 may select primary content to playback, such as an episode or movie. The timeline associated with the primary content is a presentation timeline. In the presentation timeline here, the primary content that is selected is shown.

An asset timeline may be the same as a presentation timeline if no supplemental content is interspersed in the primary content before playback. This may be referred to as a “clean” copy. For a clean copy, the primary content does not have fixed supplemental content interspersed. When supplemental content is interspersed in the primary content, which may be how the source content is received for playback as part of the delivery process, this may be referred to as a “dirty” copy. Here, supplemental content is not inserted in the primary content before playback, and this is a clean copy of the primary content. Although this is a clean copy, supplemental content may be inserted based on insertion points in the presentation timeline. The insertion may be from supplemental content found in the asset timeline. Here, the asset timeline are the individual assets that can be intermixed. Each asset contains a respective presentation timeline. The difference between the presentation timeline and the asset timeline may be the result of processing. There is nothing related to the delivery systems or addressing of media that is causing the interleaving here as the result of the original primary content.

When providing an experience to client device 104, the primary content may be combined with different types of supplemental content. While the above dirty copy methodology may be used to provide the playback experience, the dirty copy methodology directly ties processing to the experience and constraints the premutation and customization that can be done. That is, each distribution context that includes a different experience may have fixed content streams with the specific asset timelines. This may use a large amount of storage and limit flexibility. In some embodiments, the recipes treat each type of supplemental content of the experience as an independent presentation contained with its own asset. These presentations may then be combined with the primary content presentation to create the experience timeline.

The presentation timeline at 302 may be a clean copy of the primary content that has been requested. Asset timelines at 304 may include the clean copy of the primary content in addition to supplemental content labeled Ad 1, Ad 2, and Bumper. The supplemental content may be different types, such as advertisements, bumpers, etc.

The experience timeline at 306 may include a combination of the asset timelines. For example, at 308, the bumper has been inserted, at 310, a first portion of the clean copy of the primary content is inserted, at 312, Ad 1 is inserted, then a second portion of the clean copy of the primary content is inserted, at 314. Finally, at 316, Ad 2 is inserted, followed by a third portion of a clean copy of the primary content at 318.

The experience timeline is realized as a combination of multiple asset timelines that are combined at an addressing level. The addresses (e.g., links) of the asset timelines may be interleaved in the manifest. The asset timeline of the clean copy of primary content may be sliced at insertion points to allow the insertion of supplemental content from the asset timelines. The manifest may be used during playback by client device 104 to interleave the underlying asset timelines into the experience timeline.

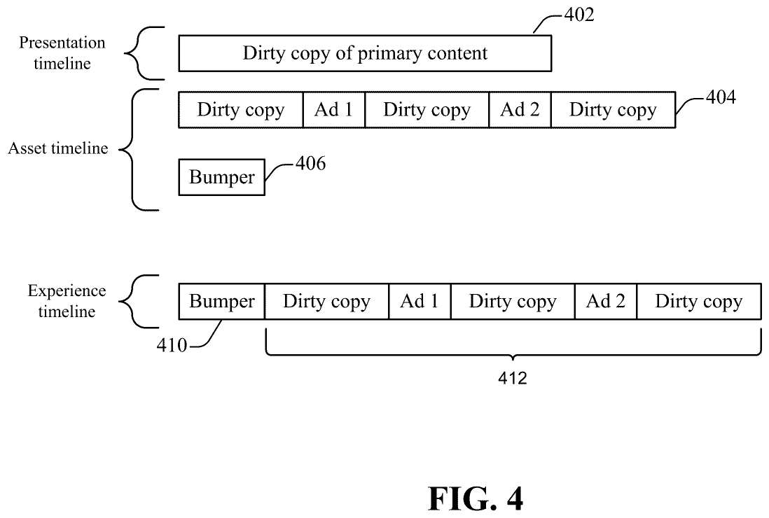

The timelines may also include dirty copies. FIG. 4 depicts an example of an experience timeline using dirty copies of assets according to some embodiments. At 402, a dirty copy of the primary content is shown on the presentation timeline. At 404, for the asset timeline, the dirty copy is shown with primary content interspersed with supplemental content of Ad 1 and Ad 2. At 406, an asset timeline of supplemental content for a bumper is provided.

The experience timeline may include different combinations of the asset timelines. For example, at 410, the bumper is inserted at an insertion point. Then, at 412, the asset timeline for the dirty copy of the primary content (from 404) is inserted. It is noted that the dirty copy of the primary content may also have additional supplemental content inserted at insertion points during the playback.

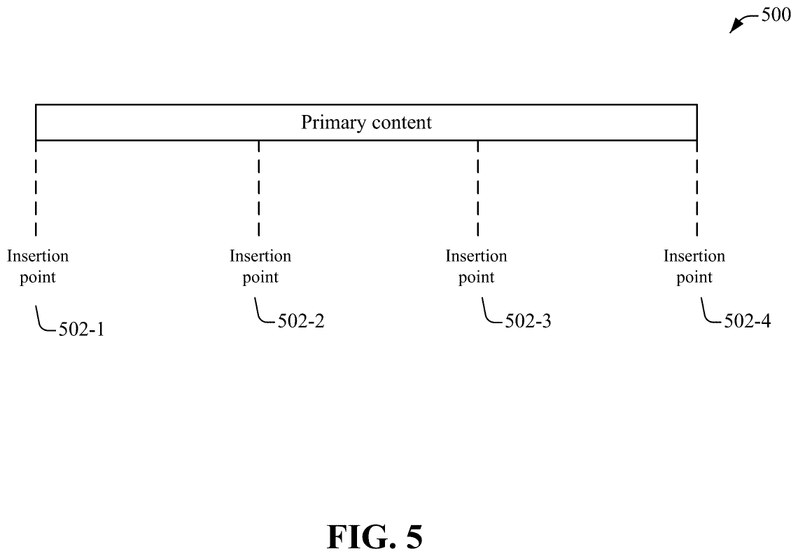

FIG. 5 depicts an example 500 of a base presentation timeline with a set of insertion points for an experience timeline according to some embodiments. As described above, the presentation timeline may be based on the primary content that was requested and is being delivered in response to the request. The primary content may be conditioned during a processing stage to enable the clean combination and splicing with other asset timelines. For example, at 502-1, 502-2, 502-3, 502-4, conditioned insertion points are shown. In some embodiments, the conditioned insertion points may be forced segmentation points of the presentation timeline. This results in insertion points that are defined within the primary content. The insertion points may be captured as part of media metadata for the primary content. These insertion points may be fixed. However, insertion points may be dynamically determined at different times, such as when a request is received, before playback starts, or during playback.

The presentation timeline of the primary content is expanded upon to create the experience timeline. The experience timeline may not be the result of the primary content creation, but is rather the result of different desires for experiences by different distribution contexts when playing back the primary content.

The recipes may determine how a presentation timeline is built. The recipe that is selected may be based on different attributes, such as the distribution context of the primary content that is being played. Other attributes such as from the playback session may also be used, such as which entitlements a user account has, which content provider is associated with the primary content, any opportunities that are desired, etc. The user entitlements may be the permissions that define which content can be played by the user account. The content provider may be which provider is providing the primary content. The context is matched to criteria of a recipe. Then, the inclusion rules of the recipe result in a set of resolution operations that should be performed for the insertion point. A recipe may be determined for each conditioned insertion point within the presentation timeline.

Insertion points in recipes may have a variety of potential operations that can be performed. The set of operations on the main presentation timeline is defined by the recipe being evaluated and used to determine the final experience timeline. Some operations may result in explicit pieces of media to include at an insertion point while other others may be signals to call an authority to perform further personalized resolution, such as to a pre-roll bumper set, in-stream promos, or advertisement opportunities.

The recipes may define types of supplemental content. Using the types allows for flexibility for determining which supplemental content to insert in a playback session for different distribution contexts. In some embodiments, the types of supplemental content may be specific content or resolution types, such as a media resolver, a bumpers resolver, an ads resolver, and a promo resolver. The media resolution may result in explicit pieces of supplemental content to include in the experience timeline. It is possible that a resolver may resolve to different pieces of media for different playback sessions. However, if the specific piece of content is specified for the insertion point, an additional resolution to determine a piece of content is not performed.

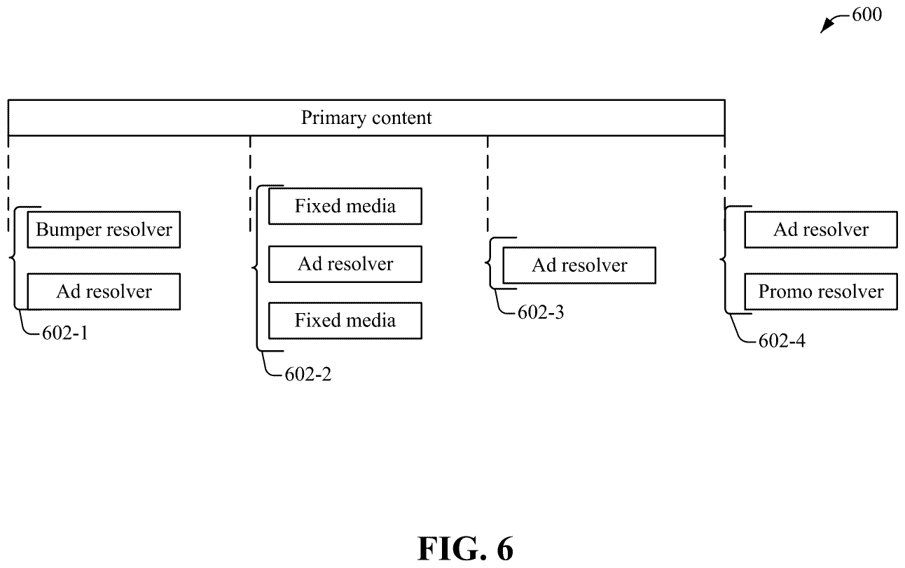

FIG. 6 depicts an example 600 of the experience timeline according to some embodiments. At 602-1, 602-2, 602-3, and 602-4, insertion points have been resolved to include different components. For example, different resolution types are included such as a bumper resolver, an ad resolver, fixed media (e.g., media that is default for multiple distribution contexts), a promo resolver, etc. Fixed media may reference the actual media that will be presented. Here, the same media may be provided for multiple playback sessions that use the recipe.

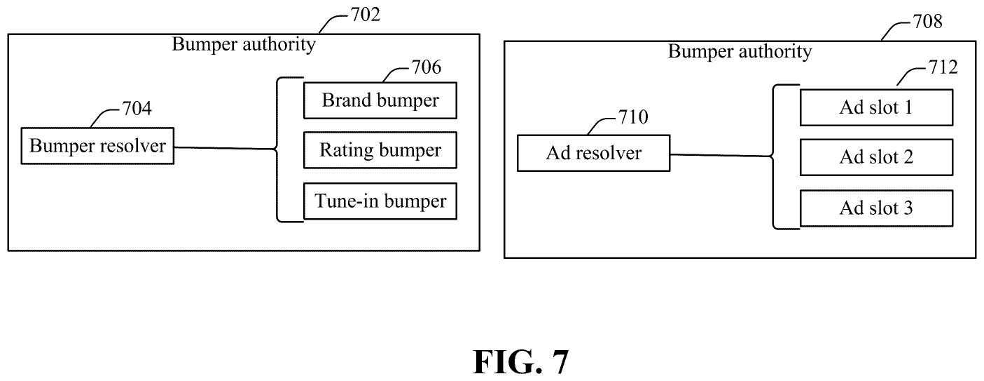

When a resolver is referred to, this may resolve to different content for different playback sessions. For example, FIG. 7 depicts examples of resolvers according to some embodiments. At 702, a bumper authority includes a bumper resolver 704 that resolves to one or more bumpers at 706, which may be a brand bumper, a rating bumper, or a tune-in bumper, but other bumpers may be included. Each bumper may be a specific piece of content. For example, the brand bumper may be a short video that promotes the brand of the video delivery system. The rating bumper may be a short video about the rating of the primary content. The tune-in bumper may be a short video that promotes an upcoming piece of content (e.g., episode, show, movie, etc.)

At 708, an ad authority may include an ad resolver 710 that resolves to one or more advertisement slots represented as ad slot 1, ad slot 2, and ad slot 3 at 712. The ad slots may be resolved to specific advertisements. Other resolvers may also be included.

The resolution points in recipes may be resolved independently and at different points in the experience timeline for different pieces of primary content. Playback orchestration system 120 may be used to perform processing of recipes. Recipes may be resolved via playback orchestration system 120. Functions described to resolve the recipes may be found in content delivery networks 118, server system 102, or client device 104. Functions described may also be distributed to different entities.

In some embodiments, different insertion concepts may be used, such as server side ad insertion (SSAI) and server-guided ad insertion (SGAI). For client devices 104 that use server-side ad insertion, the experience timeline may be fully resolved before starting playback and media player 110 is provided a manifest or a playlist that contains the presentation timelines interwoven. In this case, playback orchestration system 120 contact all resolution authorities needed by the recipe and combine all the responses into a complete experience timeline.

For client devices 104 that are server-guided ad insertion enabled, the experience timeline may be partially resolved before playback begins allowing for a more dynamic experience during playback. The amount of resolution to complete within playback orchestration system 120 may be configured and whatever is not fully resolved, client device 104 communicates with the remaining resolution authorities in a just-in-time manner to finalize the about to be played portion of the experienced timeline. For example, client device 104 may perform a resolution call to a bumper resolution authority and include a response to the player. Also, advertising resolution points may be left unresolved in the manifest or playlist. Here, the manifest or playlist may include initialized ad session tokens for client devices 104 to resolve during playback. Also, playback orchestration system 120 may provide no resolution or matching and only provides the recipe templates related to the session along with information about the experience timeline. Client device 104 then fully performs matching via tag, ID, or a combination of both. This may be used in live playback where there may be an indefinite number of breaks that may occur after playback start and will have types but not IDs to match on.

As described, recipes are used to generate the experience timeline for a playback session. The following describes the generation of recipes and the processing of recipes.

### Recipe Generation

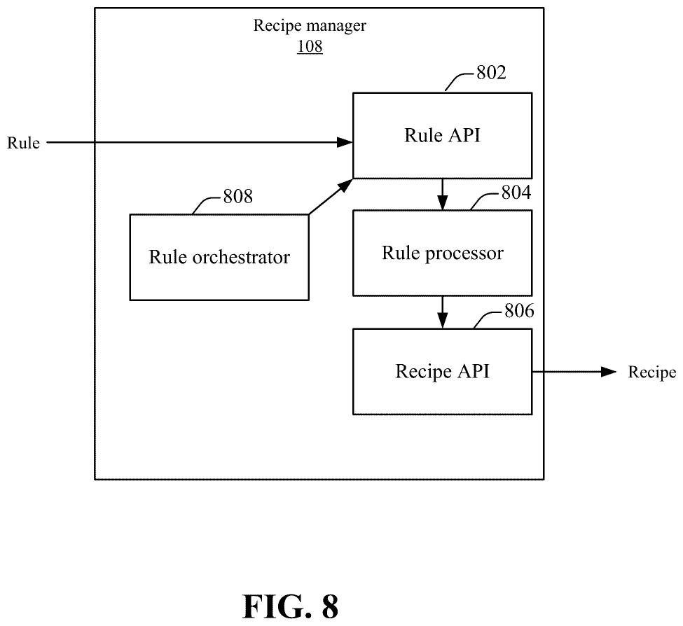

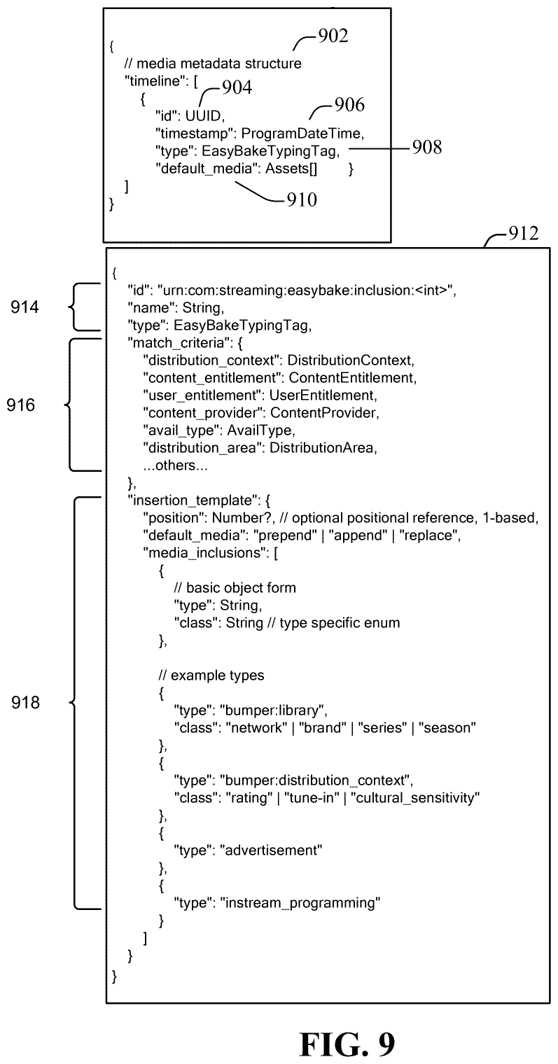

FIG. 8 depicts a more detailed example of recipe manager 108 according to some embodiments. Recipe manager 108 receives a rule as input via a rule API 802. A rule processor 804 determines insertion points that match the rule. Rule processor 804 generates a recipe based on the insertion points that were determined to match the rule. An example of a recipe will be described in FIG. 9. A recipe API 806 outputs the recipe. Content management system 106 may use the recipe when playback of primary content occurs.

A rule orchestrator 808 may perform some functions when updates are received. For example, rule orchestrator 808 may create missing recipes or clean up unused recipes that may result due to dropped insertion points or entities that are removed (e.g., primary content that is removed).

FIG. 9 depicts an example of a recipe according to some embodiments. The base media timeline decorations are objects that describe the insertion point id, media time, type, and if applicable, default content. At 902 a metadata structure for the base media timeline decorations is shown. The base media timeline decorations may include an insertion point ID 904, a media time at 906, a type at 908, and default content at 910. The insertion point ID may identify the insertion point in which inclusions rules can be selected. Different insertion points in the primary content may be identified using this metadata structure. The timestamp may be the insertion point time in the primary content. The type may be the type for the inclusion rules. The default content may be the default content that may be included. An object may be created for each insertion point in the primary content using this metadata structure.

Media inclusion rules may be objects that are used to determine whether the respective inclusion rules match an insertion point and which types of supplemental content are inserted. There may be different inclusion rules for different distribution contexts. In some embodiments, the media inclusion rules contain an ID, a tag typing, a matching criteria, and an insertion template. The insertion template describes the media references to include and how to treat default media. At 912, an example of media inclusion rules are shown. At 914, an ID, name, and type is shown. The ID may uniquely identify the inclusion rules, the name is a more readable name of the inclusion rules, and the type is the type of the inclusion rules. The type may reference the type in the base media timeline decorations object. Here, inclusion rules may be used for multiple insertion points that use the same type. This allows reuse of inclusion rules

At 916, match criteria are shown that is used to determine when these inclusion rules match an insertion point in a playback session. The match criteria include a distribution context, content entitlement, user entitlement, content provider, availability type, and a distribution area, but other criteria or combinations of criteria may be used. The information may be retrieved from different systems, such as the distribution context is retrieved based on the application being used, and the user entitlement is retrieved from a database storing user information. The distribution context may be information about the delivery application being used, the content entitlement is the entitlements for the primary content, the user entitlement is the entitlements for the user account that requested the primary content, the content provider is who provided the primary content, the availability type is the availability characteristics of the primary content, and the distribution area is a location for the user account. Other definitions of these criteria may also be appreciated. The matching criteria may allow for matching of a recipe to an insertion points if there are multiple recipes defined for an insertion point. The inclusion rules that are determined to provide the best match (e.g., match the most criteria, closest match, highest ranked match, etc.) may be selected for an insertion point.

At 918, an insertion template is provided that describes the references to include for supplemental content and how to treat default content. For example, default content or types of content may be defined. The default content may be fixed and is not resolved into different variants of content. The references for types of content may be resolved into different variants. For example, the types of a first bumper type, a second bumper type, an advertisement type, and in-stream programming type may be defined in the insertion template. The first bumper type and the second bumper type may have different classes, which may be different types of bumpers. The types in the insertion template may be speculative and may be omitted if there is not appropriate content that matches the type when evaluated using the inclusion rules.

The recipes may start in a fully template descriptive form. Here, the types of supplemental content that may be included in the insertion point are described in the template. Another recipe may define other types for the insertion point. The types may then be distilled down to a set of explicit content references that are either provided individually to client devices 104 via a SGAI system or resolved together by an SSAI system. To get from definition to usage, the recipe may be resolved or partially resolved by playback orchestration system 120 based on the evaluation of information in the recipe and attributes for the playback session. Partially resolved recipes may be further resolved by other entities, such as client device 104.

### Recipe Processing

New primary content may be ingested with a desired experience timeline. For example, primary content may be delivered with intention to show Company #1 network logo in pre-roll position and then advertisements are inserted before playback of the primary content starts for a first distribution context. For a second distribution context, a desire for advertisements may only be delivered.

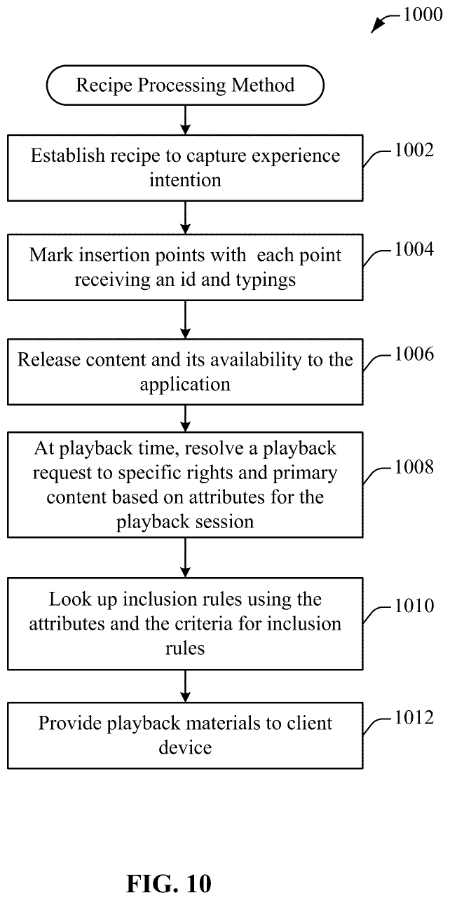

FIG. 10 depicts a simplified flowchart 1000 for processing playback of primary content according to some embodiments. The first stage may generate recipes, and then playback of primary content may use the recipes. At 1002, recipe manager 108 establishes a recipe to capture the desired experience timeline. In a first embodiment, types of supplemental content are defined. For example, a pre-roll in a first position is Company #1 bumper and ad markers are found thereafter. In a second embodiment, recipes are published as templates with match criteria. For example, the pre-roll position of Company #1 bumper transforms to {type: pre-roll, media: [{type: bumper, subtype: network, id: <Company #1>}, {type: ad-call}], match criteria: {series: <Series1>}}. The match criteria is based on the series in which this template is associated. The first embodiment may be a direct capture for a specific piece of content, e.g., a network logo and ad load before a movie. For the second embodiment, the recipe may be templated to aggregate across a larger surface. For example, all episodes of a show could have the same experience desire, so the recipe would be templatized to match on all content for that series in a single template instead of a template per episode.

At 1004, the primary content is marked with insertion points with each point receiving an id and types. The insertion point has ad markers in positions a, b, c which force conditioning points in content marked as “ad opportunity” and an additional “pre-roll” point at the beginning of the insertion point. The following types may be included in the recipe:
i. type: pre-roll, id: 1, position: 0
ii. type: ad opportunity, id: 2, position: a
iii. type: ad opportunity, id: 3, position: b
iv. type: ad opportunity, id: 4, position: c

At 1006, the primary content and its availability is released to the application. In the first embodiment, the pre-roll (specific to Series1) and ad opportunity (general to distribution context) recipes is resolved to generate an experience timeline:
i. id: 1=>Company #1 network bumper, ad server call (if ad supported user)
ii. id: 2=>ad server call (if ad supported user)
iii. id: 3=>ad server call (if ad supported user)
iv. id: 4=>ad server call (if ad supported user)
   In the second embodiment, no resolution of the recipes may be performed. At this point, the recipes may be stored and can be used for playback.

A request for primary content may be received from client device 104. At 1008, at playback time, playback orchestration system 120 resolves the playback request to specific rights and the requested primary content based on attributes for the playback session. For example, the attributes of the playback session resolve to a specific content availability (distribution context: distribution application 1, partner: Company #1, ads: allowed, etc.).

At 1010, playback orchestration system 120 looks up inclusion rules using the attributes and the matching criteria for inclusion rules. For example, playback orchestration system 120 identifies matching criteria from the available set of inclusion rules for insertion points. Then, playback orchestration system 120 selects inclusion rules for each insertion point that best matches the attributes of the playback session. For example, the attributes of the playback session may be matched to the matching criteria of inclusion rules to determine a best match of inclusion rules for an insertion point in the playback session. The best match may be the inclusion rules with a highest matching score, the most criteria matched, the closest attribute values to the criteria, etc. In the first embodiment, the resolved rights/primary content are used to look up the expanded playback timeline with final conditional details sorted out as was described in 1006. In the second embodiment, the resolved rights/primary content are used to look up matching inclusion rules for the types of insertion points. For example, Series1 has pre-roll and ad opportunity types, which, when combined with the distribution context, that includes the series being Series1, and resolves to two templates:

| | |
|---|---|
| i. | { type: pre-roll, media: [{type: bumper, subtype: network, id: |
| | <Company #1>}, {type: ad-call}], match criteria: { series: <Series1>, |
| | partner: <Company #1>}} <- specifically generated by this content |
| | set ingestion |
| ii. | { type: ad opportunity, media: [{type: ad-call}] } <- general rule for |
| | ad opportunities |

At 1012, playback orchestration system 120 provides playback materials to client device 104. The method of providing the playback materials to client device 104 may be different, such as the playback materials may be different for client devices 104 that use SGAI or SSAI. For client devices 104 that use SGAI, playback orchestration system 120 may provide the primary content link (e.g., uniform resource locator) and a resolution source, such as media ID lists or resolution authorities, for insertion points. For SSAI client devices 104, content delivery network 118 may supply client device 104 with a fully qualified experience link that has been fully resolved and includes the primary asset and insertion resolutions.

In the first embodiment, the method of providing the playback materials to client device 104 may be different, such as the playback materials may be different for client devices 104 that use SGAI or SSAI. For client devices 104 that use SGAI, playback orchestration system 120 may provide the primary content link (e.g., uniform resource locator) and a resolution source, such as resolution authorities, for insertion points. For SSAI client devices 104, playback orchestration system 120 may supply client device 104 with a fully qualified experience that has been fully resolved and includes the primary asset and insertion resolutions.

In the second embodiment, playback orchestration system 120 convert media references to explicit media links. For SSAI client devices, playback orchestration system 120 may supply client device 104 with a fully qualified experience that has been fully resolved and includes the primary asset and insertion resolutions. For client devices 104 that use SGAI, playback orchestration system 120 provides the templates to client device 104. When client device 104 encounters an insertion point, client device 104 matches the insertion point to a template based on type and further expands and resolves the media timeline. For example, client device 104 may resolve the template to specific content references. This allows templates to match an indeterminate number of insertion points meaning the templates can work on live streams where the specific number of insertion points is not known, but the types that will be used are known.

In conclusion, client devices 104 that fully support SGAI may be able to consume media in a fully componentized form, which means playback orchestration system 120 may resolve content and user account specific references while client device 104 will resolve session and add individualization references. On the other hand, client devices 104 that only support SSAI requires content references that will require playback orchestration system 120 to fully resolve all insertion points to provide a link to client device 104 that does not require further resolution.

### Example

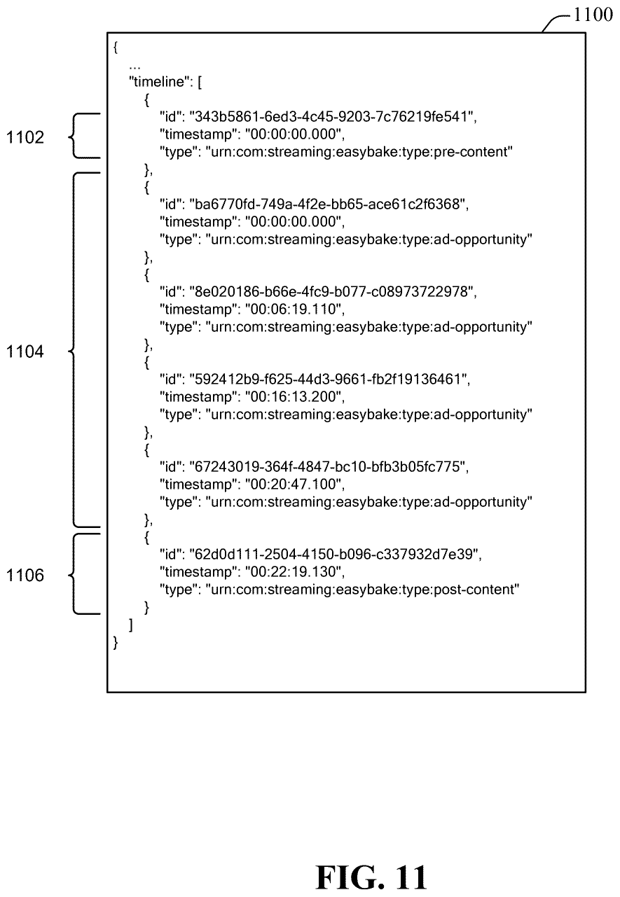

In some examples, client device 104 requests an episode of a show. FIG. 11 depicts an experience timeline 1100 that is resolved from the media presentation timeline according to some embodiments. A recipe that matches the attributes of the playback session may be used to generate the timeline. In the timeline, there are three types to resolve:
urn: com: streaming: easybake: type: pre-content at 1102.
urn: com: streaming: easybake: type: ad-opportunity at 1104.
urn: com: streaming: easybake: type: post-content at 1106.
   The three types may be a pre-content type, four ad opportunity types, and a post-content type. There may be six objects for the base media timeline decorations. The first two objects are for insertions in a first insertion point at a timestamp of “00:00:00:000” in the primary content. The next four objects are for insertions at timestamps of “00:06:19.110”, “00:16:13.200”, “00:20:47.100”, and “00:22:19.130” in the primary content.

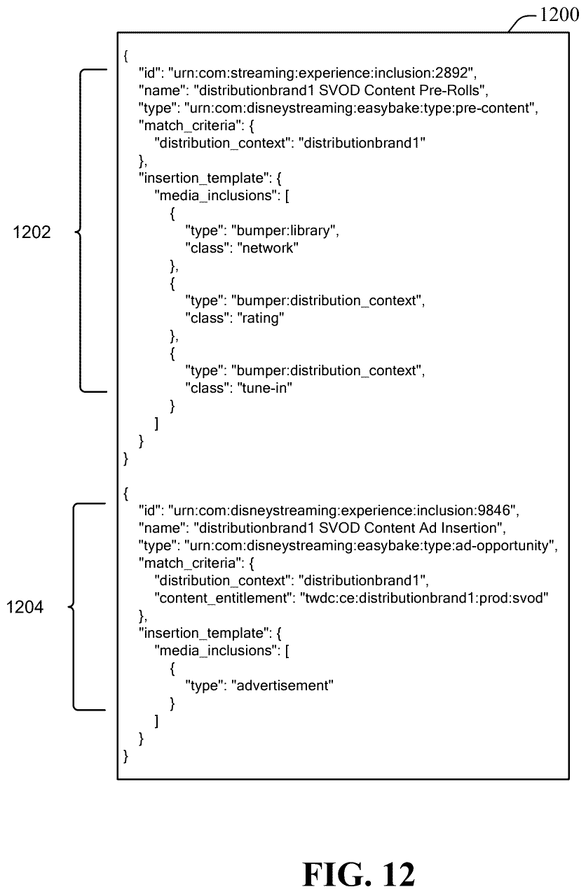

Recipe manager 108 may evaluate these types to discrete inclusion rules based on the attributes of the playback session. FIG. 12 depicts an example 1200 of the selected inclusion rules according to some embodiments. In this example, the pre-content type and the ad opportunity type are resolved while the post-content result in no match indicating no insertion or replacement should occur. The post-content may not have matched any inclusion rules based on the distribution context or other attributes of the playback session.

At 1202, the pre-content type is resolved to three bumper types. A distribution context of “distributionbrand1” is used to determine the bumper types to insert for the pre-content types. Here, distributionbrand1 may be a first distribution application. Other distribution applications may resolve to different bumper types. At 1204, the ad opportunity type is resolved to an advertisement type for distributionbrand1.

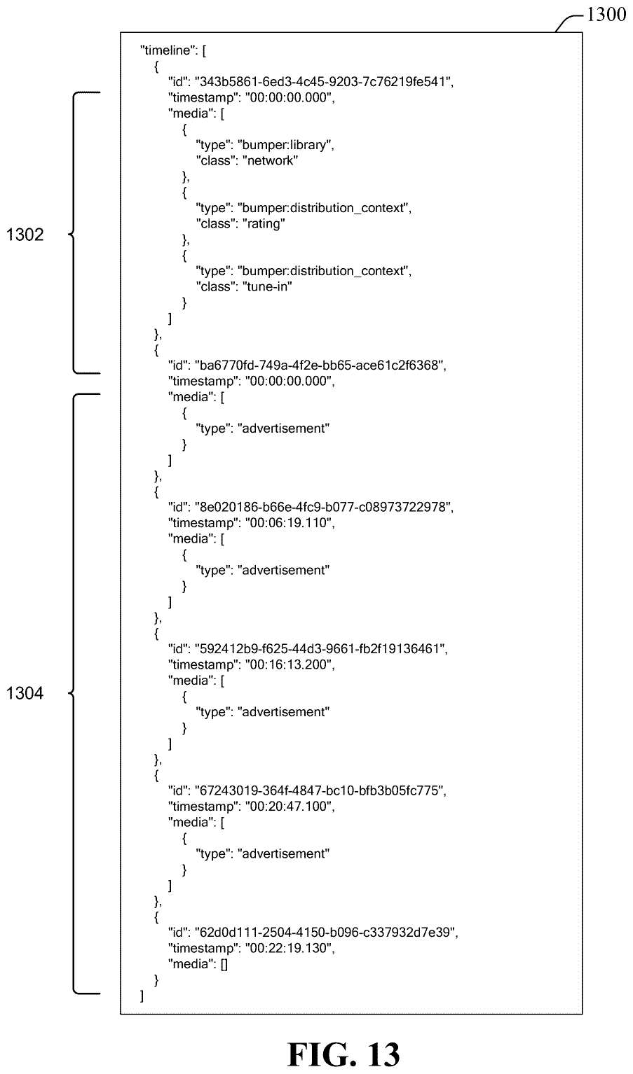

Playback orchestration system 120 would then evaluate each insertion point in the presentation timeline against the inclusion rules to generate an experience timeline. FIG. 13 depicts an example 1300 of an experience timeline after evaluation of the inclusion rules according to some embodiments. The evaluation may determine instances of the respective types. For example, at 1302, three instances of bumpers for the three bumper types are included for the insertion point at timestamp “00:00:00:000” in the primary content. The inclusion rules are used to generate the instances of bumper types.

At 1304, playback orchestration system 120 has resolved the four advertisement types at 1104 to four instances advertisement types. The four instances are for four insertion points in the experience timeline. Then, the last insertion point is not associated with any type because the post-content type did not have match any inclusion rules.

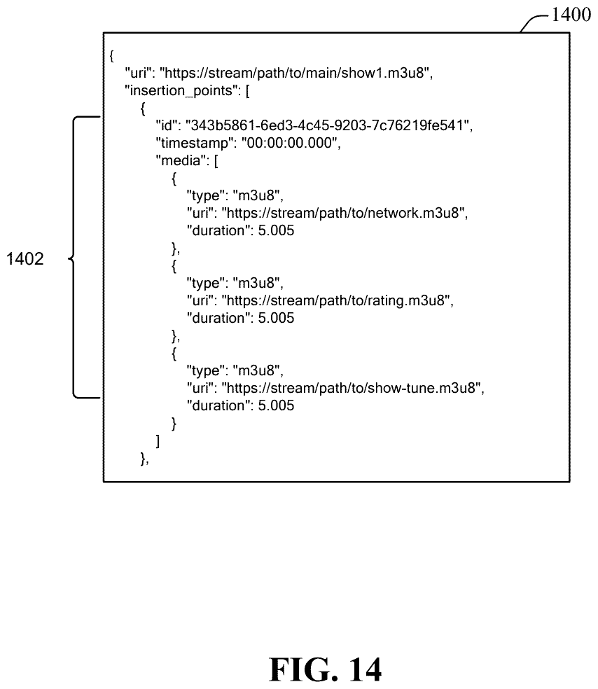

The experience timeline in FIG. 13 may be processed differently depending on the client device insertion capabilities. For SGAI, playback orchestration system 120 would resolve all bumper types to content references and provide resolution links for the advertisements. FIG. 14 depicts an example 1400 of playback materials for SGAI of the bumper types according to some embodiments. It is noted that the playback materials for the bumpers and advertisements may be included in the same file and are separated in FIGS. 13 and 14 because of space on the drawing sheets. At 1402, playback orchestration system 120 resolved the bumper types to specific links for bumpers or client device 104 may resolve the bumper types.

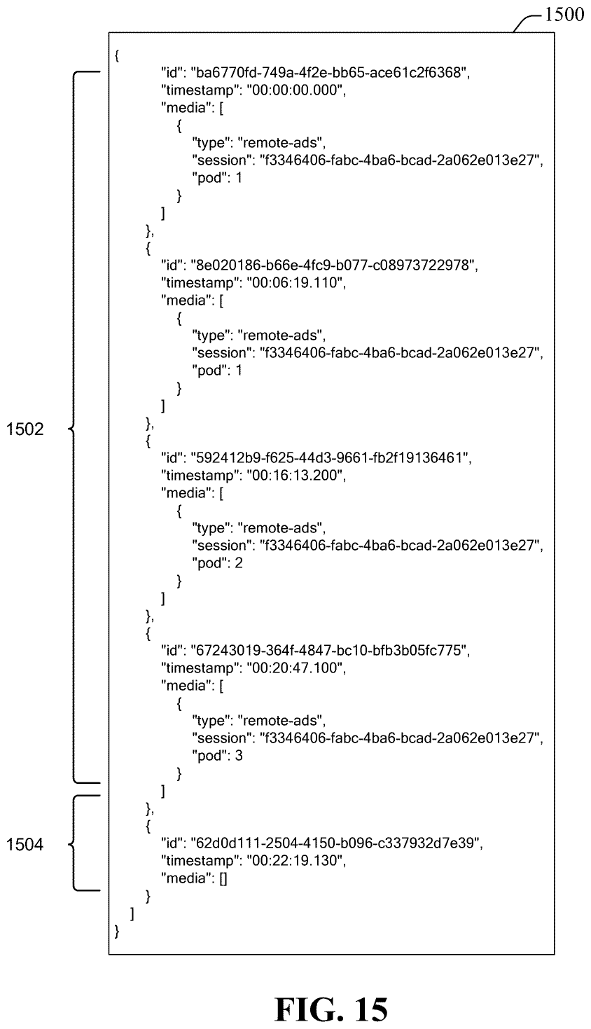

FIG. 15 depicts an example 1500 of playback materials for SGAI of the advertisement types according to some embodiments. At 1502, playback orchestration system 120 resolves the advertisement types to references for advertisements. The expectation is that SGAI client devices 104 may further resolve the “remote-ads” type references prior to the playback time and combine the remote and any explicit references into a single resolution result. At 1504, no content is inserted for the last insertion point.

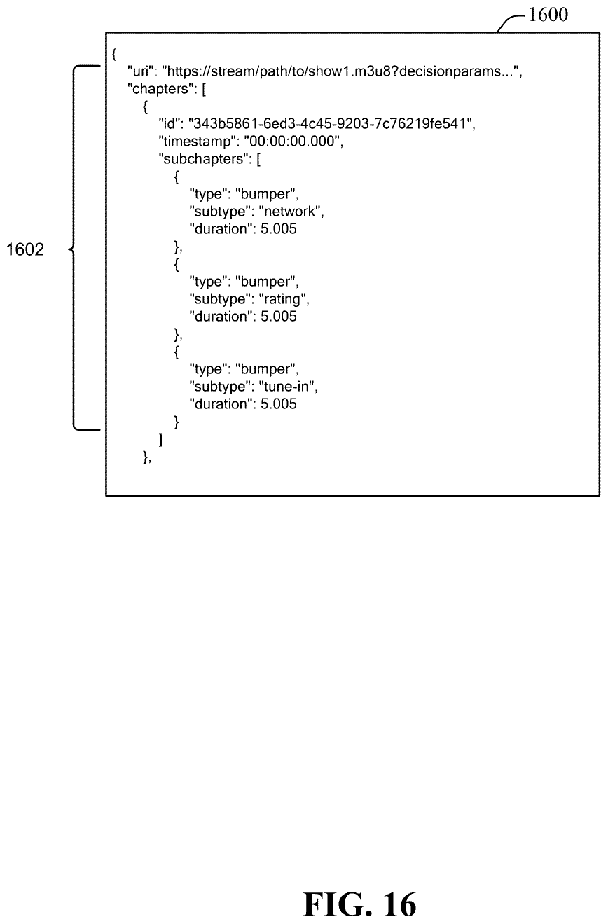

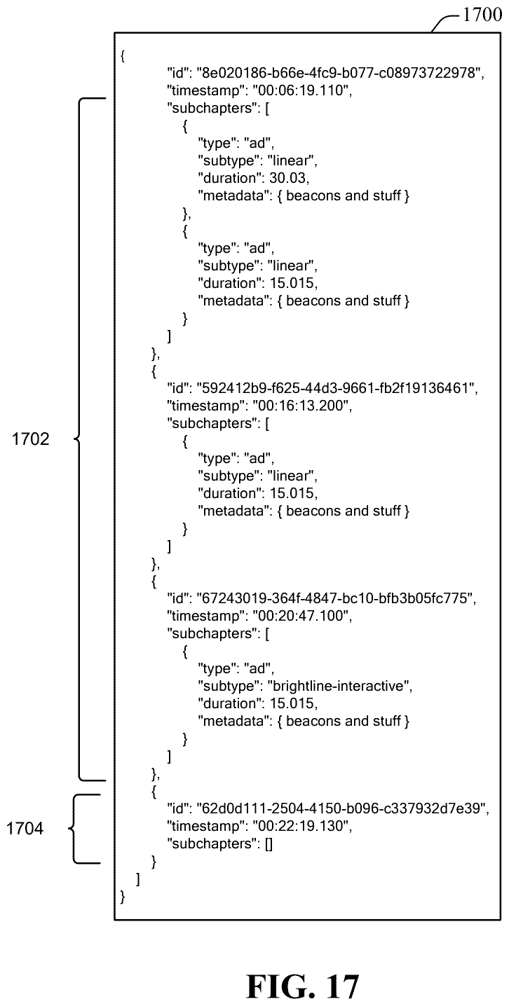

For SSAI, playback orchestration system 120 resolves all bumper types but also resolves the advertisements by calling an ad server and supplying the ad pod positioning information to receive ad resolutions. FIG. 16 depicts an example 1600 of playback materials for SSAI of the bumpers according to some embodiments. It is noted that the playback materials for the bumpers and advertisements may be included in the same file and are separated in FIGS. 16 and 17 because of space on the drawing sheets. At 1602, playback orchestration system 120 resolved the bumper types to specific links for bumpers.

FIG. 17 depicts an example 1700 of playback materials for SSAI of the advertisement references according to some embodiments. At 1702, playback orchestration system 120 resolved the advertisement types to links for advertisements. At 1704, no content is inserted for the last insertion point. The resulting playback materials may be specific SSAI links with additional ads data. In the playback materials in FIGS. 16 and 17, client device 104 does not need to resolve any references to the bumpers or advertisements. Then, the links to supplemental content can be used to request the supplemental content.

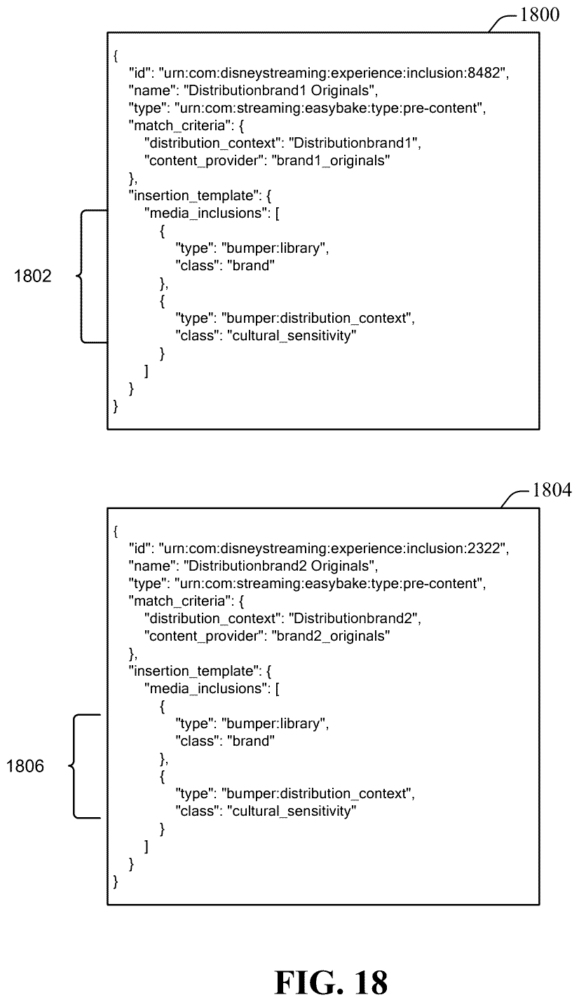

As discussed above, different recipes may be used to create different experience timelines. The following depicts an example of different supplemental content types that can be inserted at an insertion point based on different distribution contexts. FIG. 18 depicts a first example 1800 of inclusion rules for a first distribution context and a second example of inclusion rules for a second distribution context according to some embodiments. The first distribution context may be for a distribution brand 1 (distributionbrand1), which may be a first application. At 1802, the recipe template includes two bumper types. The first bumper type is brand specific and the second bumper type is for cultural sensitivity.

A second example 1804 of inclusion rules for a second distribution context is shown. The second distribution context may be for a distribution brand 2 (distributionbrand2), which may be a second application. At 1806, the recipe template includes two bumper types. The first bumper type is brand specific and the second bumper type is for cultural sensitivity. Distribution brand 1 and distribution brand 2 have similar templates due to the common product structure, but may ultimately resolve to different media due to the bumpers being brand and distribution context specific. For example, the first bumper type may resolve to different bumpers that are brand specific.

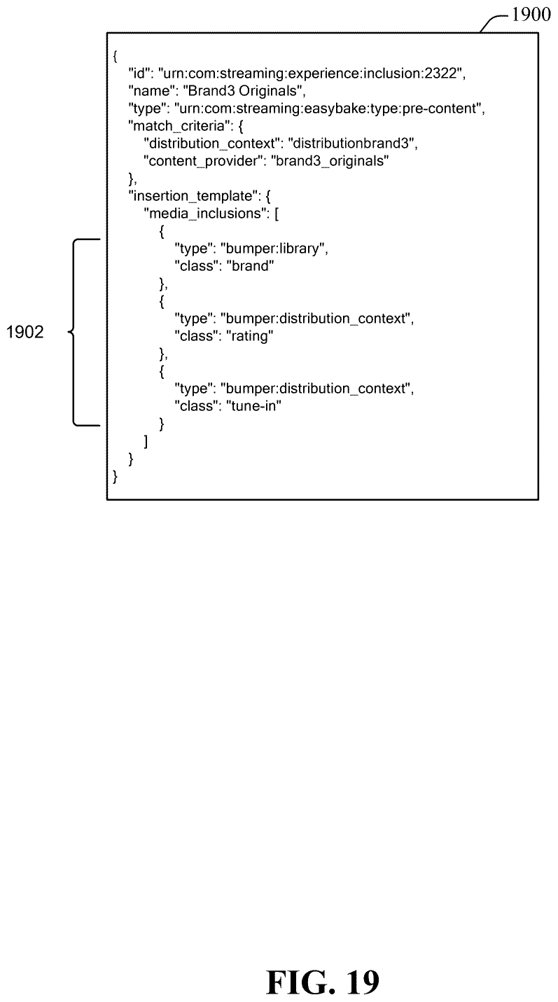

FIG. 19 depicts a third example 1900 of inclusion rules for a third distribution context according to some embodiments. The third distribution context may be for a distribution brand 3 (distributionbrand3), which may be a third application. At 1902, the recipe template includes three bumper types. These three bumper types may be different in that an extra instance of a bumper type is included. Also, the type of the bumper types may be different in that a rating bumper type and a tune-in bumper type are included instead of a cultural sensitivity bumper type. The use of different inclusion rules for an insertion point allows a single instance of base media timeline decorations to be used for primary content. The different distribution contexts may be associated with different inclusion rules for types in the base media timeline decorations. These types may be evaluated differently based on the different inclusion rules.

The use of recipes reduces an amount of computing resources used to produce and manage variations in the delivery of assets, reduces storage from componentization of pieces of content, and increases delivery efficiency due to shared resources

### CONCLUSION

Accordingly, the use of recipes allows the reuse of assets across different contexts, such as services that require different experiences for primary content. The reuse of assets improves the use of storage and also makes the system scalable. The processing of insertion points may also be dynamically determined.

### System

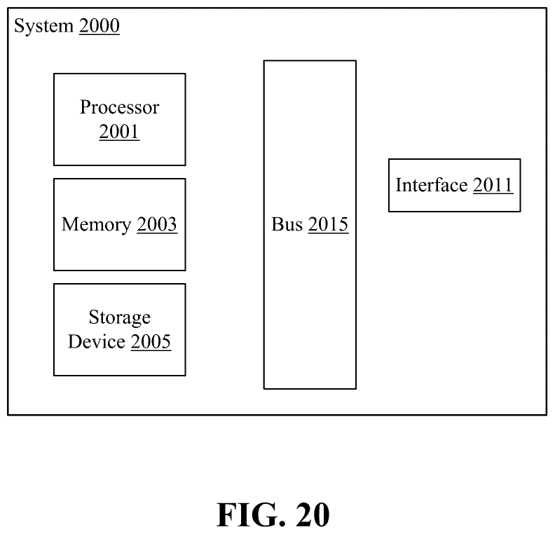

FIG. 20 illustrates one example of a computing device according to some embodiments. According to various embodiments, a system 2000 suitable for implementing embodiments described herein includes a processor 2001, a memory 2003, a storage device 2005, an interface 2011, and a bus 2015 (e.g., a PCI bus or other interconnection fabric.) System 2000 may operate as a variety of devices such as server system 102, or any other device or service described herein. Although a particular configuration is described, a variety of alternative configurations are possible. The processor 2001 may perform operations such as those described herein. Instructions for performing such operations may be embodied in the memory 2003, on one or more non-transitory computer readable media, or on some other storage device. Various specially configured devices can also be used in place of or in addition to the processor 2001. Memory 2003 may be random access memory (RAM) or other dynamic storage devices. Storage device 2005 may include a non-transitory computer-readable storage medium holding information, instructions, or some combination thereof, for example instructions that when executed by the processor 2001, cause processor 2001 to be configured or operable to perform one or more operations of a method as described herein. Bus 2015 or other communication components may support communication of information within system 2000. The interface 2011 may be connected to bus 2015 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

1. A method comprising:
receiving a request for playback of primary content, wherein the request is associated with a distribution context in a plurality of distribution contexts, wherein the distribution contexts are associated with different applications that are used to playback the primary content;
determining decorations for a set of insertion points in the primary content, wherein the decorations are associated with a set of types;
selecting inclusion rules from a plurality of inclusion rules for the distribution context, wherein the inclusion rules include a template describing references for supplemental content or default supplemental content for types in the set of types, wherein different inclusion rules in the plurality of inclusion rules are associated with different distribution contexts;
evaluating types for the set of insertion points with the template to determine an experience timeline in which insertion points are associated with references for supplemental content or default supplemental content for types in the set of types; and
determining playback materials for the set of insertion points in the primary content based on the references for supplemental content or default supplemental content for types in the set of types for the experience timeline, wherein a set of instances of supplemental content is inserted in the insertion points based on the types of supplemental content during playback of the primary content.

2. The method of claim 1, further comprising:
determining the set of insertion points in the primary content, wherein the set of types is defined for the insertion points for a plurality of distribution contexts.

3. The method of claim 1, wherein the distribution context is associated with an application that is used to playback the primary content.

4. (canceled)

5. The method of claim 1, wherein selecting the inclusion rules comprises:
determining attributes of a playback session in which the request is received, wherein the attributes include the distribution context;
analyzing criteria for inclusion rules in the plurality of inclusion rules to determine a match of criteria to the attributes; and
selecting the inclusion rules that are determined to match.

6. The method of claim 1, wherein evaluating the set of types to determine instances of types of supplemental content comprises:
determining whether a type in the set of types matches a type in the template; and
when a type does not match a type in the template, removing the type and not including any references for supplemental content or default supplemental content for the type.

7. The method of claim 1, wherein determining the playback materials comprises:
evaluating a type of supplemental content to a reference for the type of supplemental content.

8. The method of claim 7, wherein the reference is further resolved to an instance of supplemental content in the set of instances of supplemental content by a client device playing the primary content.

9. The method of claim 1, wherein determining the playback materials comprises:
evaluating a type of supplemental content to default supplemental content for the type of supplemental content.

10. The method of claim 1, wherein determining the playback materials comprises:
evaluating a type of supplemental content to a link for the type of supplemental content.

11. The method of claim 1, wherein:
the different inclusion rules include different templates to determine the experience timeline, and
the different templates result in different instances of types of supplemental content being inserted into the insertion point.

12. The method of claim 1, wherein:
the playback materials include fully resolved links for the set of instances of supplemental content.

13. The method of claim 1, wherein:
the playback materials include a reference that is resolved by a client device during playback of the primary content before the insertion point is reached.

14. The method of claim 1, wherein:
a type in the set of types results in different instances of supplemental content being inserted into an insertion point based on different distribution contexts.

15. A non-transitory computer-readable storage medium having stored thereon computer executable instructions, which when executed by a computing device, cause the computing device to be operable for:
receiving a request for playback of primary content, wherein the request is associated with a distribution context in a plurality of distribution contexts, wherein the distribution contexts are associated with different applications that are used to playback the primary content;
determining decorations for a set of insertion points in the primary content, wherein the decorations are associated with a set of types;
selecting inclusion rules from a plurality of inclusion rules for the distribution context, wherein the inclusion rules include a template describing references for supplemental content or default supplemental content for types in the set of types, wherein different inclusion rules in the plurality of inclusion rules are associated with different distribution contexts;
evaluating types for the set of insertion points with the template to determine an experience timeline in which insertion points are associated with references for supplemental content or default supplemental content for types in the set of types; and
determining playback materials for the set of insertion points in the primary content based on the references for supplemental content or default supplemental content for types in the set of types for the experience timeline, wherein a set of instances of supplemental content is inserted in the insertion points based on the types of supplemental content during playback of the primary content.

16. The non-transitory computer-readable storage medium of claim 15, wherein the distribution context is associated with an application that is used to playback the primary content.

17. The non-transitory computer-readable storage medium of claim 15, wherein selecting the inclusion rules comprises:
determining attributes of a playback session in which the request is received, wherein the attributes include the distribution context;
analyzing criteria for inclusion rules in the plurality of inclusion rules to determine a match of criteria to the attributes; and
selecting the inclusion rules that are determined to match.

18. The non-transitory computer-readable storage medium of claim 15, wherein determining the playback materials comprises:
evaluating a type of supplemental content to a reference for the type of supplemental content.

19. The non-transitory computer-readable storage medium of claim 15, wherein determining the playback materials comprises:
evaluating a type of supplemental content to default supplemental content for the type of supplemental content.

20. An apparatus comprising:
one or more computer processors; and
a computer-readable storage medium comprising instructions for controlling the one or more computer processors to be operable for:
receiving a request for playback of primary content, wherein the request is associated with a distribution context in a plurality of distribution contexts, wherein the distribution contexts are associated with different applications that are used to playback the primary content;
determining decorations for a set of insertion points in the primary content, wherein the decorations are associated with a set of types;
selecting inclusion rules from a plurality of inclusion rules for the distribution context, wherein the inclusion rules include a template describing references for supplemental content or default supplemental content for types in the set of types, wherein different inclusion rules in the plurality of inclusion rules are associated with different distribution contexts;
evaluating types for the set of insertion points with the template to determine an experience timeline in which insertion points are associated with references for supplemental content or default supplemental content for types in the set of types; and
determining playback materials for the set of insertion points in the primary content based on the references for supplemental content or default supplemental content for types in the set of types for the experience timeline, wherein a set of instances of supplemental content is inserted in the insertion points based on the types of supplemental content during playback of the primary content.

21. The non-transitory computer-readable storage medium of claim 15, wherein:
the different inclusion rules include different templates to determine the experience timeline, and
the different templates result in different instances of types of supplemental content being inserted into the insertion point.
